(19) United States
(12) Patent Application Publication
(10) Pub. No.: US 2012/0205511 A1
(43) Pub. Date: Aug. 16, 2012

(54) Seat Rail For Motor Vehicle Seats

(75) Inventor: Jochen Hofmann, Marktgraitz (DE)

(73) Assignee: Brose Fahrzeugteile GmbH & Co. Kommanditgesellschaft, Coburg, Coburg (DE)

(21) Appl. No.: 13/365,434

(22) Filed: Feb. 3, 2012

(30) Foreign Application Priority Data
Feb. 15, 2011 (DE) 102011011315.0

(51) Int. Cl. B60N 2/075; B21C 51/00

(52) U.S. Cl. 248/429; 72/46

(57) ABSTRACT

A seat rail for motor vehicle seats includes a lower rail 1 and an upper rail 2 which is displaceable relative to the lower rail 1. The lower rail 1 includes holes 4, 5 for screws or other fastening structure for fastening the lower rail 1 to the vehicle floor and the lower rail 1 includes markings for the position of the holes 4, 5 in the outer regions not concealed by the upper rail 2.

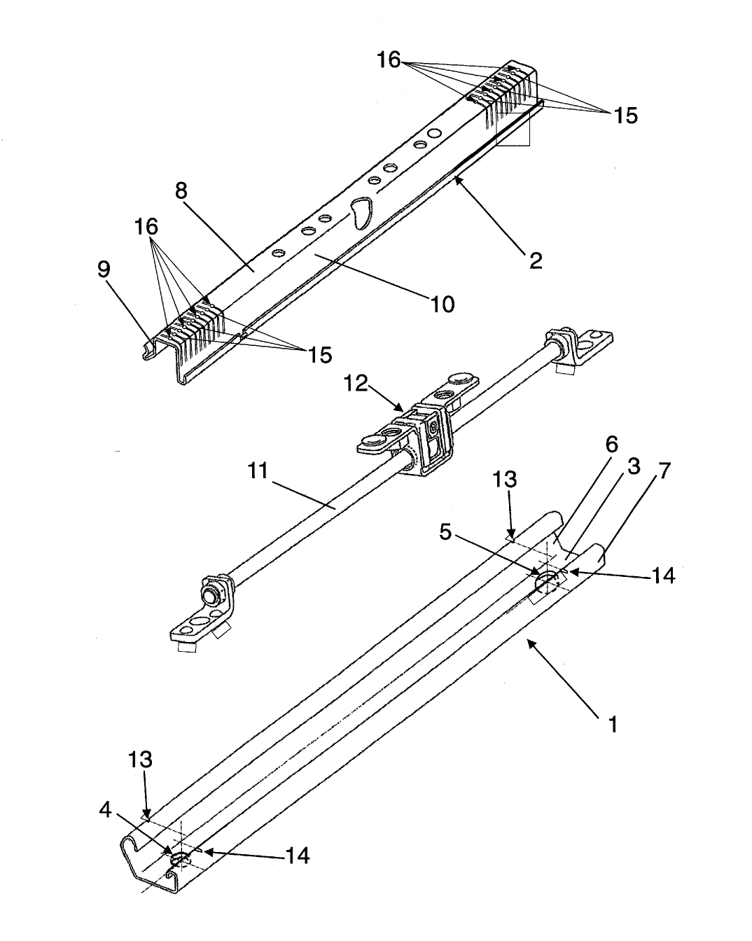

### FIELD OF THE INVENTION

The invention relates to a seat rail for motor vehicle seats which generally consists of a lower rail to be fastened to a vehicle floor and an upper rail displaceably arranged relative thereto. The vehicle seat is connected to the upper rail and thus may be displaced—depending on the arrangement of the seat rails in the vehicle—longitudinally or transversely relative to the vehicle floor. The invention further relates to a method for producing the aforementioned seat rail.

### BACKGROUND

A seat rail of the aforementioned type is disclosed in DE 102009004365 A1 and various other embodiments are known. A vehicle seat is mounted on two such rails and is generally able to be longitudinally displaced by the displacement of the upper rails relative to the lower rails fastened to the vehicle floor. However, seat rails arranged transversely in the vehicle also exist, and by means of which seats are movably mounted transversely in the vehicle.

The lower rails of the known seat rails generally comprise two holes on their lower bottom surface, through which screws are passed and fixedly screwed to a vehicle floor. The holes are generally provided in the vicinity of the ends of the lower rail. Very high strength requirements are set for the screws as they have to deflect all forces into the vehicle floor in potential accident situations.

An adjustment of the position between the upper and lower rail may take place in an electrically or manually driven manner. To this end, means for driving or locking the position between the upper and lower rail are provided in a hollow space between the lower and upper rail. Said means may, for example, be a spindle and a spindle drive, or a locking unit with locking pins may be provided in the hollow space. On rare occasions, said drive or locking means may malfunction, whereby there is the possibility that a relative movement is no longer possible between the upper and lower rail. As the drive and locking means are arranged in the aforementioned hollow space, they are no longer able to be reached in order to carry out maintenance. Depending on the position of the upper rail relative to the lower rail, at least one of the screws, by means of which the lower rails are fastened to the vehicle floor, is no longer able to be reached. The screws may be concealed by the upper rail which is locked in position. In such a case, the dismantling of the seat rails may be associated with a high degree of effort.

### SUMMARY OF THE INVENTION

It is the object of the invention to provide a seat rail which may be dismantled with as little effort as possible even when the upper and lower rail are locked in position. Moreover, a method for producing such a seat rail is intended to be set forth, by means of which the production cost of the aforementioned seat rail may be minimized.

This object is achieved in that the seat rail according to the invention is characterized by the features of Claim 1. Further details are revealed from the sub-claims. The production method according to the invention has the features set forth in claim 10.

The lower rail with the known holes for screwing to the vehicle floor comprises markings for the position of the holes which may not be concealed by the upper rail. By means of these markings, the exact position of the holes, which are potentially not visible, is still known. Irrespective of the position in which the upper rail is located and optionally locked in position, by means of the markings it is possible to determine the correct position on the upper rail at which the upper rail has to be drilled in order to be able to release, through this bore, the screw by means of which the lower rail is screwed to the vehicle floor. This is conceivably the simplest and least disruptive solution for dismantling a seat rail which is locked in position. Repeated drilling at the incorrect position by factory personnel who are inexperienced with such seldomly occurring events, as well as other conceivably disruptive solutions which are costly, are avoided.

The lower rail of the seat rail generally has side walls to the side of the aforementioned bottom surface, and by means of which a mounted connection may be made with the upper rail. It is advantageous if the markings for the position of the holes are applied on the highest possible outer regions of one or both side walls, said outer regions thus being located in the vicinity of the upper rail. Thus, in the case of dismantling being required, the markings may be transferred on a short path from the lower rail to the upper rail.

The holes in the lower rail for fastening the lower rail to the vehicle floor may be designed to be circular or as a slot, or may be of another shape. The markings should be arranged so that they are located centrally above the central point of the surface of the holes. Thus, if required, it is possible to drill the upper rail centrally above the holes and then safely remove the screws.

In a further embodiment of the invention, the upper rail may comprise marking lines in the end regions of its longitudinal extent, specifically in the regions which are able to conceal the holes of the lower rail, and which are primarily arranged in an upwardly facing top surface of the upper rail. The marking lines may also be arranged further downwards on side walls of the upper rail, so that they come close to the lower rail and the markings thereof. If the exceptional case has occurred of a seat rail locked in position, starting from the markings of the lower rail, the next marking line of the upper rail may be located and the drilling carried out on this marking line. Thus, it is particularly advantageous if on every marking line of the top surface a recess in the manner of a centre punch mark is centrally provided above the central point of the surface of the holes. Thus the positioning of the drill at the correct point and the drilling of the upper rail is possible in a particularly simple and reliable manner.

The method according to the invention for producing the seat rail provides that the markings of the lower rail and the marking lines and recesses are produced on the upper rail as part of the forming process of the lower rail and upper rail. In the process of metal forming, the holes for fastening the lower rail to the vehicle floor are incorporated in the material and in the same process the markings may be incorporated in the metal without any extra effort being necessary. Also, the marking lines and recesses in the material of the upper rail are thus able to be produced without extra effort during the metal forming process. It is also advantageous if markings, marking lines or recesses stamped into the metal of the seat rail remain clearly visible even after the seat rail has been painted.

### DESCRIPTION OF THE DRAWING

The invention is described hereinafter with reference to an exemplary embodiment. The associated FIGURE shows a seat rail according to the invention in a perspective exploded view, wherein details which are irrelevant to the invention are not able to be shown.

### DESCRIPTION OF AN EXAMPLE EMBODIMENT

The seat rail consists of a lower rail 1 and an upper rail 2. The lower rail 1 comprises a bottom surface 3 in which holes 4, 5 are provided, through which screws may be passed for fastening the lower rail 1 to a vehicle floor. Side walls 6, 7 of the lower rail 1 are adjoined to the bottom surface 3 on both sides. The upper rail 2 has a top surface 8 and proceeding therefrom side walls 9, 10 facing downwards. The side walls 6, 9 and 7, 10 of the lower rail 1 and the upper rail 2 provide hooking and mounting options, known per se, between the lower rail 1 and the upper rail 2 so that said rails are guided on one another in a longitudinally displaceable manner in the mounted state.

A spindle drive is arranged in a hollow space formed by the lower rail 1 and the upper rail 2, the position between the lower rail 1 and the upper rail 2 being able to be adjusted via said spindle drive. Thus, for example, the position of a vehicle seat fastened to the upper rail 2 (and a further upper rail 2 of a further seat rail) may be adjusted in the vehicle interior in the longitudinal direction. The spindle drive consists of a spindle 11 to be fastened to the lower rail 1 and a gear mechanism 12 which may be driven and which is to be fastened to the upper rail 2. Alternatively, with the presence of a manual seat adjuster a locking device, known per se, could also be arranged in the hollow space, and via which the relative position is able to be set between the lower rail and the upper rail.

Viewed in the longitudinal extent of the lower rail 1, a central point of the surface of the holes 4, 5 is located at a specific distance from the ends of the lower rail 1. At the same distance, markings 13, 14 are arranged on upper edges of the side walls 6, 7 of the lower rail 1. An imaginary transverse connection between the markings 13, 14 is thus located above the central point of the surface of the holes 4, 5. The markings 13, 14 are also still visible after mounting the upper rail 2, irrespective of the adjusted longitudinal position in which it is located relative to the lower rail 1. Thus the position of the holes 4, 5 would still be known, even if the holes were to be concealed by the upper rail 2. The markings 13, 14 are produced in one operating step in the method for producing the lower rail 1, during the forming thereof, for example when bending or punching holes.

The upper rail 2 is also provided in its end portions with markings in the form of marking lines 15 and recesses 16. The marking lines 15 are provided, in particular, on the top surface 8 and the side wall 10 transversely to the direction of extension of the upper rail 2. In specific adjusted positions of the upper rail 2 relative to the lower rail 1, in each case a marking line 15 is aligned with the markings 13, 14 of the lower rail 1. Thus the position of the holes 4, 5 and thus of the screws, by means of which the lower rail 1 is fastened to the vehicle floor, may be transferred directly without aids to the top surface 8 of the upper rail 2. The distance of the marking lines 15 from one another is very short. If the markings 13, of the lower rail 1 were located in an adjusted position of the upper rail 2 between two marking lines 15, it would be possible to ignore the resulting error.

In each case, approximately in the middle of the top surface 8 of the upper rail 2, on each marking line 15 and thus exactly above the potential central point of the surface of the holes 4, 5, the recesses 16 are incorporated in the material of the upper rail 2. They serve in the manner of a centre punch mark for easily locating the correct drilling position and for improving the drilling behaviour. Should it be necessary to release the floor screws guided through the holes 4, 5 when the gear mechanism 12 is locked in position, the upper rail 2 may be easily drilled at the correct point if it conceals one of the screws. The screw may then be released through the drilled hole.

In the upper rail 2 it also applies that the marking lines 15 and recesses 16 are produced in one operating step in the method for producing the upper rail 2, during the forming thereof, for example when bending or punching holes. The markings 13, 14 and the marking lines 15 and recesses 16 should be produced so that they are clearly visible even after the seat rail has been painted. However, a forming process which negatively influences the inner surface of the lower rail 1 or upper rail 2 and thus the running behaviour of the upper rail 2 in the lower rail 1 should not be carried out.

1. A seat rail for motor vehicle seats comprising:
a lower rail,
an upper rail which is displaceable relative to the lower rail,
wherein the lower rail comprises holes for screws or other fastening means for fastening the lower rail to the vehicle floor and wherein the lower rail comprises markings for the position of the holes in the outer regions not concealed by the upper rail.

2. The seat rail of claim 1, wherein the holes are located in a lower bottom surface of the lower rail and the markings are applied to an upper edge of a side wall of the lower rail.

3. The seat rail of claim 1, wherein the markings are arranged on upper edges of two side walls of the lower rail, in each case on both sides of the holes.

4. The seat rail of claim 1, wherein the holes 4, 5) are configured to be circular or as a slot, and the markings are arranged approximately perpendicular above the central point of the surface of the holes.

5. The seat rail of claim 1, wherein the lower rail comprises two holes for fastening to the vehicle floor and comprises at least one marking per hole.

6. The seat rail of claim 1, wherein the upper rail, in the end regions of its longitudinal extent in an upwardly facing top surface, comprises a number of marking lines arranged transversely to its longitudinal extent.

7. The seat rail of claim 6, wherein the marking lines of the upper rail reach as far as the region of the markings of the lower rail.

8. The seat rail of claim 7, wherein a number of recesses in the manner of centre punch marks is stamped in the top surface of the upper rail, wherein a recess is located in each case on one respective marking line above the holes.

9. The seat rail of claim 1, wherein elements of a device for adjusting or locking the relative position between the lower rail and the upper rail are located in a hollow space enclosed by the lower rail and the upper rail.

10. A method for producing a seat rail for motor vehicle seats, the seat rail comprising a lower rail and an upper rail which in each case are produced by a metal forming process, wherein the lower rail during the metal forming process is provided with holes for subsequent fastening of the lower rail to a vehicle floor, the method comprising the step of
during the metal forming process arranging stamped portions for marking the position of the holes in a region of the lower rail which is still subsequently visible from the outside.
